(19) United States
(12) Patent Application Publication
(10) Pub. No.: US 2020/0119685 A1
(43) Pub. Date: Apr. 16, 2020

(54) MULTILAYER SOLAR MODULE INSTALLATION STRUCTURE

(71) Applicant: Jong Kyu NAM, Pohang-si (KR)

(72) Inventor: Jong Kyu NAM, Pohang-si (KR)

(21) Appl. No.: 16/601,649

(22) Filed: Oct. 15, 2019

(30) Foreign Application Priority Data
Oct. 15, 2018 (KR) 10-2018-0122508

(51) Int. Cl. H02S 20/32; H02S 20/30

(52) U.S. Cl. CPC H02S 20/32; H02S 20/30

(57) ABSTRACT

Disclosed herein is a multilayer solar module installation structure. The multilayer solar module installation structure includes: a pair of frames which are spaced apart from each other, and in which guide grooves are formed through the opposite side surfaces thereof in longitudinal directions; and solar modules which are installed on upper and lower sides between the frames so that they are movable along the guide grooves, and which convert the solar energy of incident solar light into electric energy. Through this configuration, the solar modules are disposed on the upper and lower sides of the frames, thereby achieving the effect of efficiently using a solar light installation space.

### CROSS-REFERENCE TO RELATED APPLICATION

This application claims the benefit of Korean Patent Application No. 10-2018-012508 filed on Oct. 15, 2018, which is hereby incorporated by reference herein in its entirety.

### BACKGROUND

### 1. Technical Field

The present invention relates generally to a multilayer solar module installation structure, and more specifically to a structure in which solar modules configured to receive solar energy and then convert the solar energy into electric energy are installed in multiple layers.

### 2. Description of the Related Art

In recent years, due to global warming caused by the massive use of fossil fuel and environmental destruction, abnormal changes in climate have occurred and the scale of damage from natural disasters has increased. As a means for resolving the above problems, the development and use of alternative energy are actively being performed. Among these attempts, solar modules which provide pollution-free energy and are economical are attracting attention.

Generally, a solar module generates electricity by using a phenomenon (a photoelectric effect) in which electricity is generated when solar light is incident on a solar cell composed of a silicon semiconductor or the like.

In recent years, thanks to the development of solar cell-related technology, research and commercialization in the field of photovoltaic power generation are actively being performed.

However, such solar modules require relatively large land because power generation efficiency is proportional to the installation area of solar cells.

Therefore, when solar modules are installed in a small area, a problem arises in that the amount of power generated is small. In contrast, when solar modules are installed in a large area, a problem arises in that forest used for the large area is destructed.

### PATENT DOCUMENTS

(Patent document 1) Korean Patent Application No. 10-2011-0100672

(Patent document 2) Korean Patent Application No. 10-2011-0090918

(Patent document 3) Korean Patent Application No. 10-2008-0020278

(Patent document 4) Korean Patent Application No. 10-2015-0110494

### SUMMARY

The present invention has been conceived to overcome the above-described problems, and an object of the present invention is to minimize the area required for the installation of solar modules, thereby enabling the solar modules to be installed within a small space and also preventing a forest area from being excessively consumed.

Another object of the present invention is to prevent solar modules from being blocked by their shadows.

In order to accomplish the above objects, an embodiment of the present invention provides a multilayer solar module installation structure including: a pair of frames which are spaced apart from each other, and in which guide grooves are formed through the opposite side surfaces thereof in longitudinal directions; and solar modules which are installed on upper and lower sides between the frames so that they are movable along the guide grooves, and which convert the solar energy of incident solar light into electric energy.

The frames may be each formed in a waveform shape in which the upper and lower parts thereof are the same and bent in front-back directions, and the solar modules may be located at foremost and backmost locations, respectively, or uppermost and lowermost locations, respectively, in order to prevent incident sunlight from being blocked by them.

Moving members configured to be coupled into the guide grooves may be provided on both sides of each of the solar modules, and each of the moving members may include: a rotating shaft configured to be coupled to the center of a corresponding one of both sides of the solar module; a first link configured such that one end thereof is coupled to one end of the rotating shaft and the other end thereof is disposed forward; a rotating roller configured to be coupled to the other end of the first link and to be disposed on the front portion of the inner circumferential surface of the guide groove; a second link configured such that one end thereof is coupled to one end of the rotating shaft and the other end thereof is disposed backward; and a first rotating gear configured to be coupled to the other end of the second link and to be engaged with a rack gear formed on the back portion of the inner circumferential surface of the guide groove.

A toothed wheel may be formed around the other of the rotating shaft, and a second rotating gear configured to be engaged with the toothed wheel may be formed on the corresponding one of both sides of the solar module.

A rainwater sensor configured to detect rainwater when it rains and a solar light tracking sensor configured to track the angle of the sun may be provided on the top of each of the frames; a control unit is installed on the top of the frame, and functions to receive a first sensor value and a second sensor value from the rainwater sensor and the solar light tracking sensor and to control a first drive motor and a second drive motor configured to drive the first rotating gear and the second rotating gear, respectively; and the control unit may rotate the solar modules in a lateral direction when rainwater is detected, and may dispose the solar modules at foremost and backmost positions and rotate the solar modules in a lateral direction at noon.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view of a multilayer solar module installation structure according to a preferred embodiment of the present invention;

FIGS. 2 and 3 are views showing the operation of frames according to a preferred embodiment of the present invention;

FIGS. 4 and 5 are enlarged views of a moving member according to a preferred embodiment of the present invention; and

FIG. 6 is a block diagram of a control unit according to a preferred embodiment of the present invention.

### DETAILED DESCRIPTION

The advantages and features of the present invention and methods for achieving them will be apparent from embodiments which will be described in detail below in conjunction with the accompanying drawings.

However, the present invention is not limited to the embodiments which will be disclosed below, but may be implemented in various different forms. The described embodiments are provided to make the disclosure of the present invention complete and to fully convey the scope of the present invention to those having ordinary skill in the art to which the present invention pertains, and the present invention is defined only by the scope of the attached claims. Throughout the specification, like reference symbols denote like components.

The present invention will be described below with reference to the drawings illustrating a multilayer solar module installation structure by using the embodiments of the present invention.

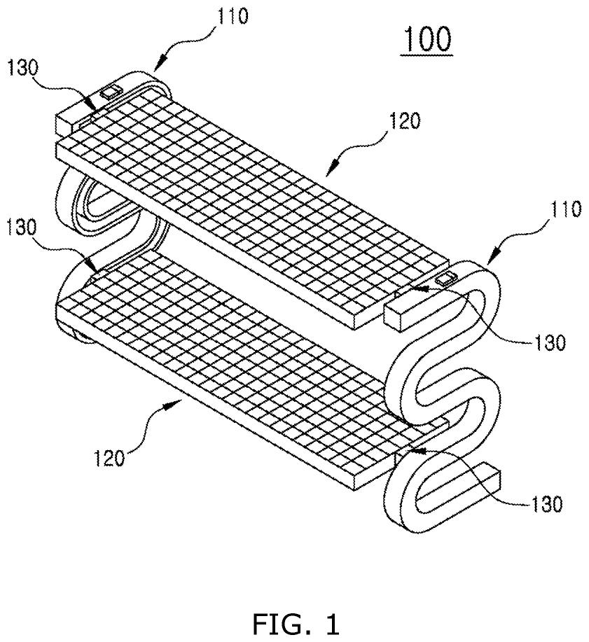

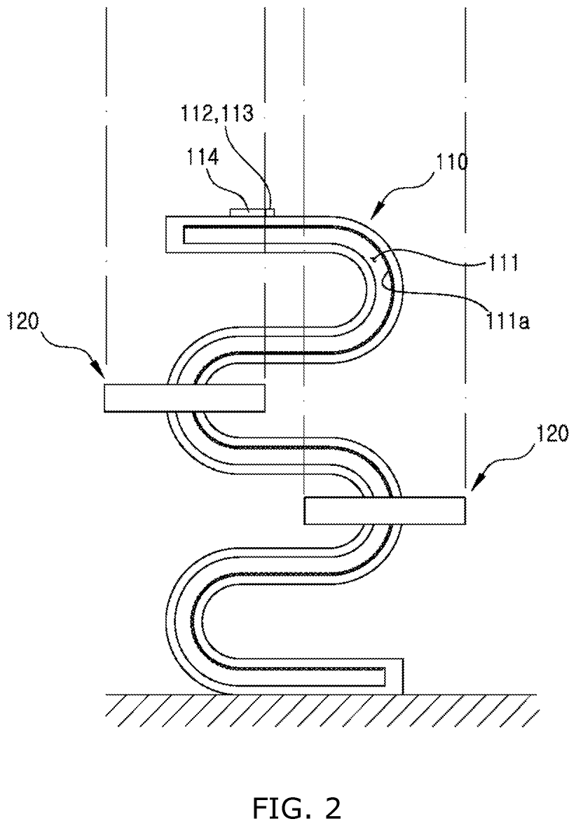

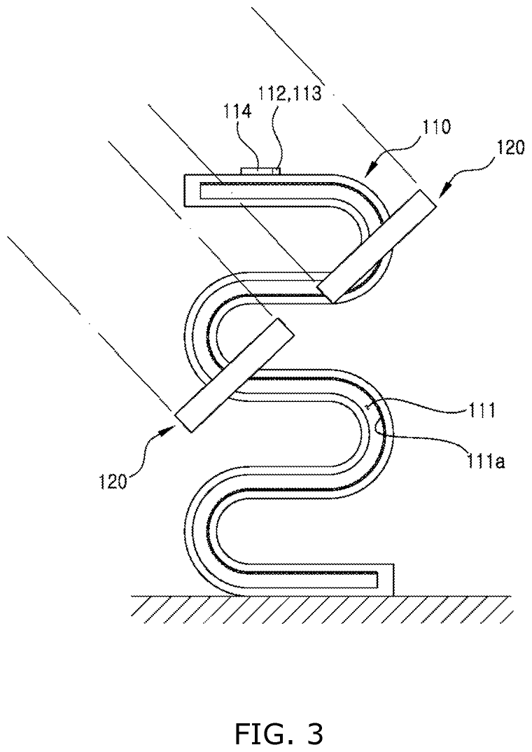

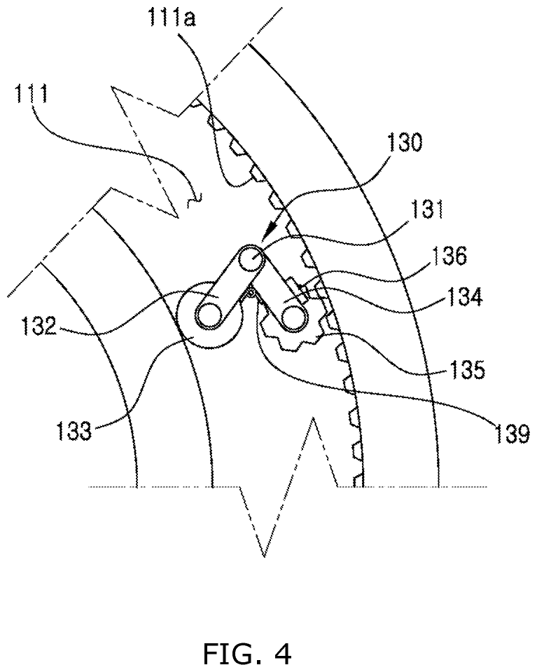

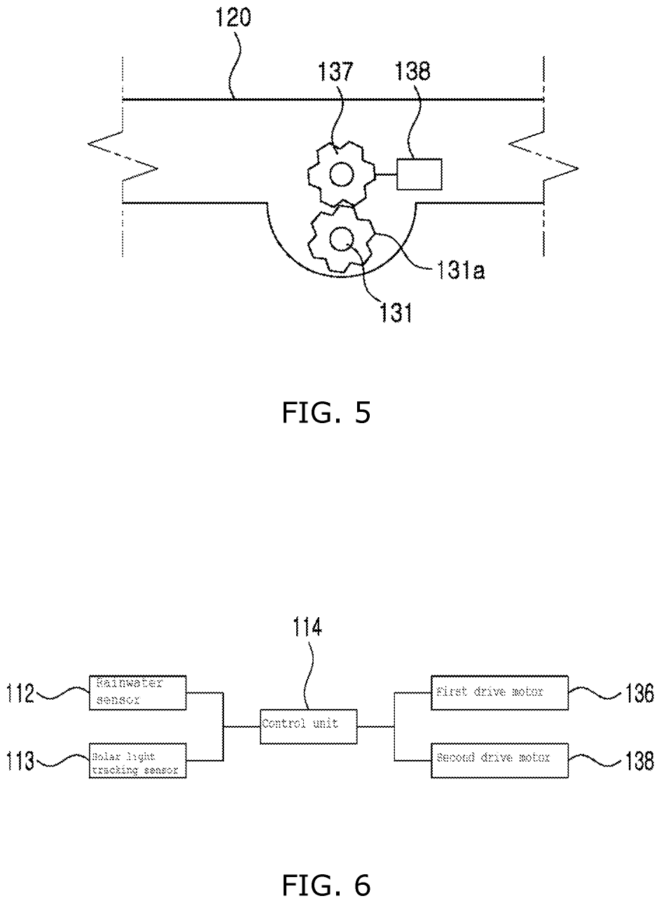

FIG. 1 is a perspective view of a multilayer solar module installation structure according to a preferred embodiment of the present invention, FIGS. 2 and 3 are views showing the operation of frames according to a preferred embodiment of the present invention, FIGS. 4 and 5 are enlarged views of a moving member according to a preferred embodiment of the present invention, and FIG. 6 is a block diagram of a control unit according to a preferred embodiment of the present invention.

Referring to these drawings, the multilayer solar module installation structure according to the present embodiment is characterized by vertically disposing a plurality of solar modules in parallel with each other, thereby enabling an installation space to be efficiently used and also preventing sunlight from being blocked by a shadow according to the location of the sun.

The multilayer solar module installation structure 100 according to the present embodiment, which is capable of providing the above effects, includes frames 110 and solar modules 120.

The frames 110 are installed upward on the ground surface, and include a pair of frames which are spaced apart from each other on both sides.

In this case, the frames 110 are formed to be opposite to each other, and guide grooves 111 are formed through respective opposite side surfaces in the longitudinal directions thereof.

In this case, each of the frames 110 is formed in a waveform shape in which upper and lower parts are bent in front-back directions, and the upper and lower parts are formed in the same manner.

The upper and lower parts of the frame 110 are each formed in about “S” shape, and the guide groove 111 is formed to correspond to the frame 110.

A rack gear 111a is formed on the back of the inner circumferential surface of the guide groove 111 in a longitudinal direction.

The solar modules 120 convert the solar energy of incident solar light into electric energy, are arranged between the frames 110, and are disposed at upper and lower locations.

In this case, the frames 110 and the solar modules 120 may be arranged in three or more layers other than two layers.

Both sides of each of the solar modules 120 are movably coupled into the guide grooves 111 of the frames 110.

More specifically, moving members 130 configured to be movably coupled into the guide grooves 111 are coupled to both sides of each of the solar modules 120.

The moving members 130 are formed at the centers of both sides of the bottom of the solar module 120, and each include a rotating shaft 131, a first link 132, a rotating roller 133, a second link 134, and a first rotating gear 135.

The rotating shaft 131 is coupled to a corresponding of both sides of the solar module 120.

The first link 132 is coupled such that one end thereof is rotatably coupled to one end of the rotating shaft 131 and the other end thereof is disposed forward.

The rotating roller 133 is coupled to the other end of the first link 132.

In this case, the rotating roller 133 is disposed on the front portion of the inner surface of the guide groove 111.

The second link 134 is coupled such that one end thereof is rotatably coupled to one end of the rotating shaft 131 and the other end thereof is disposed backward.

The first rotating gear 135 is coupled to the other end of the second link 134.

In this case, the first rotating gear 135 is disposed on the back portion of the inner surface of the guide groove 111, and is engaged with the rack gear 111a of the guide groove 111.

In this case, a first drive motor 136 configured to drive the first rotating gear 135 is installed at the other end of the second link 134.

Furthermore, an elastic element 139 is provided between the first link 132 and the second link 134, and the elastic element 139 has elastic force which spreads the other ends of the first link 132 and the second link 134.

Accordingly, in the moving member 130, the rotating roller 133 of the first link 132 and the first rotating gear 135 of the second link 134 come into close contact with and are fastened to the guide groove 111 by the elastic element 139, and the solar module 120 may be moved along the guide groove 111 through the driving of the first rotating gear 135.

Meanwhile, the locations of sunlight and shadows vary depending on the location (angle) of the sun. Accordingly, it is preferable that the solar modules 120 be moved along the guide grooves 111.

In other words, when the sun is located at the top, the solar module 120 located on the upper sides of the frames 110 is moved to and disposed on any one of the foremost and backmost sides of an “S”-shaped part, and the solar module 120 located on the lower sides of the frames 110 is moved to and disposed on the other one, thereby preventing blocking from being caused by a shadow.

Furthermore, when the sun is located forward or diagonally forward, the solar module 120 located on the upper side is moved to and disposed on the uppermost side, and the solar module 120 located on the lower side is moved to and disposed on the lowermost side, thereby preventing blocking from being caused by a shadow.

As described above, the solar modules 120 located on the upper and lower sides are moved and disposed according to the angle of the sun, thereby achieving the effect of preventing blocking from being caused by a shadow and the effect of efficiently receiving sunlight and maximizing energy efficiency.

Furthermore, the solar modules 120 are provided to be rotatable by the rotating shafts 131.

More specifically, toothed wheels 131a are formed around the other ends of the rotating shafts 131, and second rotating gears 137 configured to be engaged with the toothed wheels 131a of the rotating shafts 131 are formed on both sides of each of the solar modules 120.

A second drive motor 138 configured to drive the second rotating gear 137 is provided on one side of the second rotating gear 137.

Accordingly, each of the solar modules 120 is rotated along the toothed wheels 131a to thus adjust the angle thereof in response to the operation of the second rotating gears 137.

Through this configuration, the solar module 120 provides the effect of preventing blocking from being caused by a shadow depending on the location of the sun and the effect of maximizing energy efficiency.

Meanwhile, a rainwater sensor 112 configured to detect rainwater when it rains and a solar light tracking sensor 113 configured to track the angle of the sun are provided on the top of each of the frames 110.

Furthermore, a control unit 114 is installed on the top of each of the frames 110, and functions to receive a first sensor value, i.e., a rainwater detection value, and a second sensor value, i.e., an angle value of the sun from the rainwater sensor 112 and the solar light tracking sensor 113 and to control the first drive motor 136 and the second drive motor 138 configured to drive the first rotating gear 135 and the second rotating gear 137, respectively.

Accordingly, the solar modules 120 can be prevented from being damaged and broken by rain when it rains, thereby achieving the effect of improving durability.

Furthermore, the solar modules 120 are rotated and moved according to the location of the sun, thereby achieving the effect of maximizing energy efficiency.

In accordance with the multilayer solar module installation structure according to the present invention, the solar modules are disposed on the upper and lower sides of the frames, thereby achieving the effect of efficiently using a solar light installation space.

Furthermore, the frames are each formed in a waveform shape, and thus the solar modules may be prevented from being blocked from sunlight by a shadow, thereby achieving the effect of maximizing energy efficiency.

It will be understood by those having ordinary skill in the art to which the present invention pertains that the present invention may be practiced in other specific forms without departing from the technical spirit or essential feature thereof. Therefore, it should be understood that the embodiments described above are illustrative but not restrictive in all respects. The scope of the present invention is defined by the claims rather than the detailed description, and all alterations or modifications derived from the meaning and scope of the claims and their equivalents should be interpreted as being included in the scope of the present invention.

What is claimed is:

1. A multilayer solar module installation structure comprising:
a pair of frames which are spaced apart from each other, and in which guide grooves are formed through opposite side surfaces thereof in longitudinal directions; and
solar modules which are installed on upper and lower sides between the frames so that they are movable along the guide grooves, and which convert solar energy of incident solar light into electric energy;
wherein the frames are each formed in a waveform shape in which upper and lower parts thereof are identical and bent in front-back directions;
wherein the solar modules are located at foremost and backmost locations, respectively, or uppermost and lowermost locations, respectively, in order to prevent incident sunlight from being blocked by them;
wherein moving members configured to be coupled into the guide grooves are provided on both sides of each of the solar modules;
wherein each of the moving members comprises:
a rotating shaft configured to be coupled to a center of a corresponding one of both sides of the solar module;
a first link configured such that one end thereof is coupled to one end of the rotating shaft and a remaining end thereof is disposed forward;
a rotating roller configured to be coupled to a remaining end of the first link and to be disposed on a front portion of an inner circumferential surface of the guide groove;
a second link configured such that one end thereof is coupled to one end of the rotating shaft and a remaining end thereof is disposed backward; and
a first rotating gear configured to be coupled to a remaining end of the second link and to be engaged with a rack gear formed on a back portion of the inner circumferential surface of the guide groove.

2. The multilayer solar module installation structure of claim 1, wherein:
a toothed wheel is formed around a remaining end of the rotating shaft; and
a second rotating gear configured to be engaged with the toothed wheel is formed on the corresponding one of both sides of the solar module.

3. The multilayer solar module installation structure of claim 2, wherein:
a rainwater sensor configured to detect rainwater when it rains and a solar light tracking sensor configured to track an angle of a sun are provided on a top of each of the frames;
a control unit is installed on the top of the frame, and functions to receive a first sensor value and a second sensor value from the rainwater sensor and the solar light tracking sensor and to control a first drive motor and a second drive motor configured to drive the first rotating gear and the second rotating gear, respectively; and
the control unit rotates the solar modules in a longitudinal direction when rainwater is detected, and disposes the solar modules at foremost and backmost positions and rotates the solar modules in a longitudinal direction at noon.
